(19) United States
(12) Patent Application Publication
(10) Pub. No.: US 2018/0052345 A1
(43) Pub. Date: Feb. 22, 2018

(54) PROJECTOR

(71) Applicant: SEIKO EPSON CORPORATION, Tokyo (JP)

(72) Inventor: Makoto OTANI, Matsumoto-Shi (JP)

(73) Assignee: SEIKO EPSON CORPORATION, Tokyo (JP)

(21) Appl. No.: 15/556,948

(22) PCT Filed: Feb. 29, 2016
(86) PCT No.: PCT/JP2016/001080

§ 371 Date: Sep. 8, 2017

(30) Foreign Application Priority Data
Mar. 20, 2015 (JP) 2015-057418

(51) Int. Cl. G02F 1/1347; H04N 9/31; G03B 21/14

(52) U.S. Cl. CPC G02F 1/1347; H04N 9/3167; G03B 21/16; G03B 21/145; G03B 21/14; H04N 9/3126

(57) ABSTRACT

A projector includes an optical unit forming an image and a optical projection device projecting the image formed. The optical unit includes a first illumination device, a first light modulation device modulating light emitted from the first illumination device, and a dimming device disposed on an optical path between the first illumination device and the first light modulation device and adjusting, on a region-by-region basis, the illuminance of the light emitted from the first illumination device. The dimming device includes a second light modulation device of reflection type modulating the light emitted from the first illumination device, and a relay device of reflection type forming an image of the modulated light modulated by the second light modulation device on the first light modulation device.

### TECHNICAL FIELD

The present invention relates to a projector.

### BACKGROUND ART

A projector including a light source device, a light modulation device that modulates light emitted from the light source device, and a optical projection device that projects the modulated light has been conventionally known. As such a projector, a projector including two light modulation devices that are optically connected in series for the purpose of improving the contrast in a projected image has been proposed (e.g., see PTL 1).

In the projector disclosed in PTL 1, after the light emitted from a light source unit passes through a homogenizing illumination system and a reflection mirror, the light is separated into red, green, and blue color lights by a plurality of dichroic mirrors. Then, the respective color lights are modulated by corresponding liquid crystal light valves (color modulation light valves) as first modulation units, and combined by a cross dichroic prism. After this, the light combined the cross dichroic prism passes through a relay optical system having both-side telecentric characteristics, in which optical members such as a front lens group, an aperture stop, and a rear lens group are linearly disposed, and is incident on a luminance modulation unit. The luminance modulation unit modulates the incident light (image light formed by the color modulation light valve) with a liquid crystal light valve (luminance modulation light valve) to adjust the amount of light on a pixel-by-pixel basis. Then, the light passing through the luminance modulation unit is projected by a projection lens. With the configuration described above, the gray scale of the projected image can be extended, and the contrast can be improved.

### CITATION LIST

### Patent Literature

PTL 1: JP-A-2007-218946

### SUMMARY OF INVENTION

### Technical Problem

Incidentally, some types of projectors are not provided with a dimming device including the luminance modulation light valve. When optical design or component design is performed individually for the projector and the projector provided with the dimming device and the relay optical system described above, manufacturing costs are increased, and in addition, a time is required for development. For this reason, a configuration allowing optical design or component design to be shared between different types is desired.

The invention is aimed at solving at least a portion of the problems described above, and it is one of the objects of the invention to provide a projector allowing an optical system to be shared between different types.

### Solution to Problem

A projector according to a first aspect of the invention includes: an image forming device forming an image; and a optical projection device projecting the image formed, the image forming device including an illumination device, a first light modulation device modulating light emitted from the illumination device, and a dimming device disposed on an optical path between the illumination device and the first light modulation device and adjusting, on a region-by-region basis, the illuminance of the light emitted from the illumination device in a plane orthogonal to a central axis of the light, the dimming device including a second light modulation device of reflection type modulating the light emitted from the illumination device, and a relay device of reflection type forming an image of modulated light modulated by the second light modulation device on the first light modulation device.

According to the first aspect, the dimming device includes the second light modulation device and the relay device, which are of reflection type. In the dimming device, the light from the illumination device is modulated and reflected by the second light modulation device of reflection type, and an image of the reflected modulated light is formed on the first light modulation device by the relay device of reflection type.

In the dimming device configured as described above, the optical path can be designed such that the optical path length from the illumination device to the second light modulation device is substantially the same as the optical path length from the illumination device to the first light modulation device in the case of provisionally removing the dimming device (i.e., the arrangement position of the second light modulation device or the relay device, the optical design of the relay device, and the like can be appropriately set). Due to this, a projector not having a dimming function can be configured by removing the dimming device from the projector, and commonality of most of constituent components can be achieved between the projector including the dimming device and a projector of another type not including the dimming device. Accordingly, costs in manufacturing a plurality of different types can be reduced, and in addition, the time required to develop the plurality of types can be shortened.

In the first aspect, it is preferable that the dimming device includes a polarization separation device directing the modulated light incident from the second light modulation device to the relay device and emitting the modulated light reflected by the relay device to the first light modulation device side, and a retardation film disposed between the polarization separation device and the relay device and converting incident light to substantially circularly polarized light.

According to the first aspect, in the dimming device, the modulated light modulated by the second light modulation device is incident on the polarization separation device, passes through the polarization separation device, and is incident on the relay device of reflection type. After the modulated light is incident on the relay device of reflection type and reflected by the relay device, the modulated light is incident as substantially circularly polarized light on the relay device of reflection type, in the course of being emitted from the relay device and incident again on the polarization separation device, and the rotational direction of the circularly polarized light is reversed by reflection, whereby the polarization direction is converted. Accordingly, the modulated light incident from the second light modulation device and the modulated light reflected by the relay device can be reliably separated by the polarization separation device by the difference in polarization direction. Due to this, the modulated light by the second light modulation device can be reliably directed to the relay device, and in addition, the modulated light reflected by the relay device and whose image is formed on the first light modulation device can be reliably emitted to the first light modulation device side.

Then, in the dimming device, after the modulated light travels back and forth between the polarization separation device and the relay device due to reflection, the modulated light is emitted from the polarization separation device to the first light modulation device side, and therefore, the configurations of the dimming device can be compactly disposed. Accordingly, the dimming device can be downsized, and thus the projector can be downsized.

In the first aspect, it is preferable that the dimming device emits light incident along a first direction in a second direction substantially orthogonal to the first direction.

According to the first aspect, in the projector not provided with the dimming device for example, the dimming device can be disposed at the arrangement position of a mirror that changes a light traveling direction by reflection, and in addition, the mirror can be omitted.

In the first aspect, it is preferable that the second light modulation device is disposed on the first direction side with respect to the polarization separation device, and that the relay device is disposed on a side opposite to the second direction with respect to the polarization separation device.

According to the first aspect, the light incident along the first direction from the illumination device is incident on the second light modulation device through the polarization separation device, and the modulated light reflected by the second light modulation device is incident again on the polarization separation device. Then, the modulated light is reflected in the direction opposite to the second direction by the polarization separation device and incident on the relay device, and the modulated light reflected by the relay device is emitted in the second direction through the polarization separation device. According to this, the configurations of the dimming device can be disposed reliably compactly. In addition to this, since the light incident along the first direction can be reliably emitted along the second direction, the projector including the dimming device can be simply configured by disposing the dimming device instead of the mirror.

In the first aspect, it is preferable that the dimming device emits light incident along a first direction along the first direction.

According to the first aspect, the incident direction of light on the dimming device and the emission direction of modulated light by the dimming device coincide with each other. According to this, the dimming device can be easily disposed on the optical path of light emitted from the illumination device in the projector without the dimming device. Accordingly, the projector not including the dimming device can be made only by removing the dimming device from the projector including the dimming device. Moreover, since the arrangement orientation of the dimming device can be changed, space can be effectively utilized, and the projector can be downsized.

In the first aspect, it is preferable that the second light modulation device is disposed in a third direction substantially orthogonal to the first direction with respect to the polarization separation device, and that the relay device is disposed on a side opposite to the third direction with respect to the polarization separation device.

According to the first aspect, the light incident along the first direction from the illumination device is reflected in the third direction by the polarization separation device and incident on the second light modulation device, and the modulated light reflected by the second light modulation device is incident again on the polarization separation device. The modulated light is incident through the polarization separation device on the relay device located on the side opposite to the second light modulation device with the polarization separation device interposed between the relay device and the second light modulation device. Then, the modulated light is reflected by the relay device, incident on the polarization separation device, reflected by the polarization separation device, and emitted in the first direction. According to this, the configurations of the dimming device can be disposed reliably compactly. In addition to this, since the light incident along the first direction is emitted along the first direction, the projector not including the dimming device can be made only by removing the dimming device from the projector including the dimming device.

In the dimming device, when the dimming device is viewed along the first direction, the second light modulation device and the relay device are disposed on opposite sides from each other with the polarization separation device interposed therebetween. For this reason, when the second light modulation device and the relay device are disposed so as to face each other along the horizontal direction, the arrangement of the second light modulation device and the relay device can be selected considering space efficiency. Further, the second light modulation device and the relay device can be disposed so as to face each other along the vertical direction. Accordingly, the projector can be downsized.

A projector according to a second aspect of the invention includes: an image forming device forming an image; and a optical projection device projecting the image formed, the image forming device including an illumination device, a first light modulation device modulating light emitted from the illumination device, and an optical component housing in which the first light modulation device can be disposed at a predetermined position, the optical component housing being configured such that a dimming device adjusting, on a region-by-region basis, the illuminance of the light emitted from the illumination device in a plane orthogonal to a central axis of the light can be disposed on an optical path between the illumination device and the first light modulation device, the dimming device including a second light modulation device of reflection type modulating the light emitted from the illumination device, a relay device of reflection type forming an image of modulated light modulated by the second light modulation device on the first light modulation device, a polarization separation device directing the modulated light incident from the second light modulation device to the relay device and emitting the modulated light reflected by the relay device to the first light modulation device side, and a retardation film disposed between the polarization separation device and the relay device and converting incident light to substantially circularly polarized light.

According to the second aspect, similarly to the projector according to the first aspect, the optical path of the dimming device can be designed such that the optical path length from the illumination device to the second light modulation device is substantially the same as the optical path length from the illumination device to the first light modulation device in the case of provisionally removing the dimming device. Due to this, commonality of most of constituent components can be achieved between the projector including the dimming device and a projector of another type not including the dimming device. Accordingly, costs in manufacturing a plurality of different types can be reduced, and in addition, the time required to develop the plurality of types can be shortened.

In the second aspect, it is preferable that when the dimming device is not disposed in the optical component housing, a reflection device reflecting at least portion of light is disposed at a place at which the polarization separation device can be disposed.

According to the second aspect, the projector not including the dimming device can be simply configured by disposing the reflection device at the arrangement position of the dimming device.

### BRIEF DESCRIPTION OF DRAWINGS

FIG. 1 is a schematic view showing the configuration of a projector according to a first embodiment of the invention.

FIG. 2 is a schematic view showing the configuration of a dimming device in the first embodiment.

FIG. 3 is a schematic view showing the configuration of another projector in the first embodiment.

FIG. 4 is a schematic view showing the configuration of a projector according to a second embodiment of the invention.

FIG. 5 is a schematic view showing the configuration of another projector in the second embodiment.

FIG. 6 is a schematic view showing the configuration of a projector according to a third embodiment of the invention.

FIG. 7 is a schematic view showing the configuration of the projector in the third embodiment.

FIG. 8 is a schematic view showing the configuration of a dimming device in the third embodiment.

FIG. 9 is a schematic view showing the configuration of another projector in the third embodiment.

FIG. 10 is a schematic view showing the configuration of another projector in the third embodiment.

### DESCRIPTION OF EMBODIMENTS

### First Embodiment

Hereinafter, a first embodiment of the invention will be described based on the drawings.

### [Schematic Configuration of Projector]

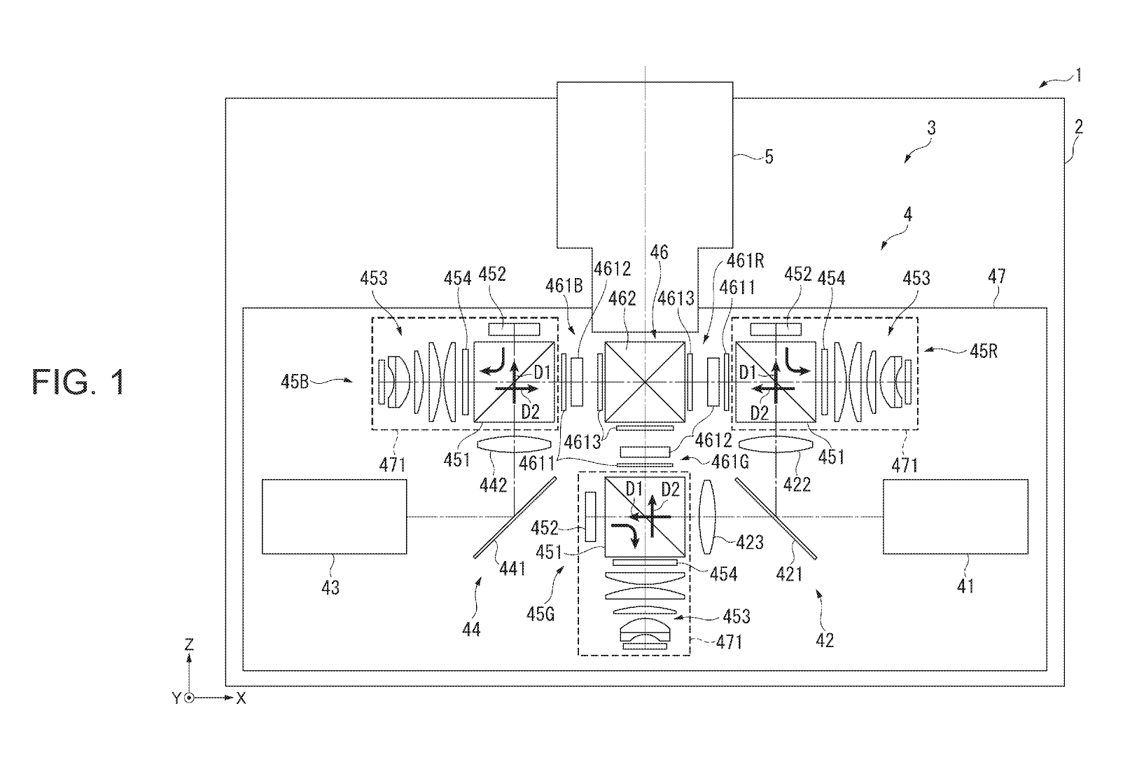

FIG. 1 is a schematic view showing the configuration of a projector 1 according to the embodiment.

The projector 1 according to the embodiment is an image display device that modulates light emitted from a first illumination device 41 and a second illumination device 43, which are provided therein, to form an image in response to image information, and enlarges and projects the image onto a projection surface (not shown) such as a screen. As shown in FIG. 1, the projector 1 includes an external housing 2 having a substantially rectangular shape in a plan view and constituting the exterior of the projector 1, and a device main body 3 accommodated in the external housing 2.

### [Configuration of Device Main Body]

The device main body 3 includes an optical unit 4 that forms a projection image and a optical projection device 5. In addition to them, although not shown in the drawing, the device main body 3 includes a cooling device that cools a cooling object in the projector 1, a power source device that supplies power to constituent components of the projector 1, and a control device that controls the operation of the projector 1.

### [Configuration of Optical Projection Device]

The optical projection device 5 enlarges and projects the projection image formed by the optical unit 4 onto the projection surface. The optical projection device 5 is configured as a coupling lens including a plurality of lenses (not shown) and a lens barrel accommodating the plurality of lenses therein.

In the following description, in the case where the projector 1 is disposed with the bottom surface portion of the external housing 2 facing an installation surface, the projection direction of the image by the optical projection device 5 is defined as a Z-direction, a direction orthogonal to the Z-direction and directed from the bottom surface portion toward the top surface portion (a direction from the lower side toward the upper side in the vertical direction) is defined as a Y-direction, and a direction orthogonal to the Y-direction and the Z-direction and directed from the left toward the right along the horizontal direction when viewed along the Z-direction is defined as an X-direction.

### [Configuration of Optical Unit]

The optical unit 4 includes a first illumination device 41, a color separation device 42, a second illumination device 43, a light guide device 44, dimming devices 45, an electro-optic device 46, and an optical component housing 47 that accommodates the devices 41 to 46 as optical components contributing to the formation of an image. The devices 41 to 46 are disposed at predetermined positions with respect to a design illumination optical axis that is set inside the optical component housing 47.

### [Configuration of First Illumination Device]

The first illumination device 41 emits illumination light that contains red light and green light and whose illuminance in the plane orthogonal to the central axis of luminous flux is uniform, in the direction opposite to the X-direction. Moreover, the first illumination device 41 emits, as the illumination light, linearly polarized light whose polarization direction (the vibration direction of an electric field) is a direction (a direction parallel to the Z-axis) orthogonal to the optical axis in the ZX plane.

p-polarized light and s-polarized light are defined with respect to a polarization separation layer 4511 of a polarization separation device 451 included in the dimming device 45 to be described later.

Although not shown in the drawing, the first illumination device 41 includes a light source device that emits light containing red light and green light, and a homogenizing device as an integrator optical system.

The light source device described above includes solid-state light sources respectively corresponding to the red light and the green light.

The light source device may employ a configuration including a solid-state light source that emits excitation light and a phosphor layer that emits fluorescence in response to the excitation light, in which blue light (emission intensity peak: approximately 445 nm) as the excitation light is incident from the solid-state light source on the phosphor layer to emit red light and green light from the phosphor layer.

Moreover, the homogenizing device includes a first lens array, a second lens array, a polarization conversion element, and a superimposing lens. The first lens array of these divides incident luminous flux into a plurality of partial luminous fluxes, and the second lens array superimposes, in cooperation with the superimposing lens, the plurality of partial luminous fluxes incident from the first lens array on a second light modulation device 452 for dimming to be described later. The polarization conversion element converts light to p-polarized light.

### [Configuration of Color Separation Device]

The color separation device 42 separates luminous flux incident from the first illumination device 41 into two color lights of red and green, and causes the color lights to be incident on the dimming devices 45 corresponding thereto. The color separation device 42 includes a dichroic mirror 421 and field lenses 422 and 423.

The dichroic mirror 421 reflects in the Z-direction the red light contained in the illumination light incident in the direction opposite to the X-direction, and transmits the green light. The red light reflected by the dichroic mirror 421 is incident in the Z-direction on the dimming device 45R for red through the field lens 422. On the other hand, the green light transmitted through the dichroic mirror 421 is incident in the direction opposite to the X-direction on the dimming device 45G for green through the field lens 423. The dimming devices 45R and 45G, which will be described in detail later, adjust the illuminances of the color lights and cause the modulated lights to be incident on the electro-optic device 46.

### [Configuration of Second Illumination Device]

The second illumination device 43 emits, as illumination light, blue light whose illuminance in the plane orthogonal to the central axis of luminous flux is uniform, in the X-direction. Moreover, the second illumination device 43 emits p-polarized light as the illumination light similarly to the first illumination device 41.

Although not shown in the drawing, the second illumination device 43 includes a solid-state light source that emits blue light and various optical elements such as a rod integrator lens as an integrator optical system.

### [Configuration of Light Guide Device]

The light guide device 44 causes the blue color light as the luminous flux incident from the second illumination device 43 to be incident on the corresponding dimming device 45. The light guide device 44 includes a mirror 441 and a field lens 442. The blue light emitted in the X-direction from the second illumination device 43 is incident on the mirror 441, reflected in the Z-direction, and incident in the Z-direction on the dimming device 45B for blue through the field lens 442. The dimming device 45B, which will be described in detail later, adjusts the illuminance of blue light and causes the modulated light to be incident on the electro-optic device 46.

### [Configuration of Electro-Optic Device]

The electro-optic device 46 modulates the modulated lights, emitted from the dimming devices 45 to be described later and corresponding to the respective colors of red, green, and blue, on a color-by-color basis to form image lights of the respective colors, and combines the image lights to form a projection image. The electro-optic device 46 includes first light modulation devices 461 provided corresponding to the respective color lights, and a cross dichroic prism 462 as a color combination device.

The first light modulation device 461 modulates incident color light in response to an image signal, and causes the color light to be incident on the cross dichroic prism 462 as image light.

The first light modulation device 461 includes an incident-side polarizer 4611 that transmits p-polarized light, a liquid crystal panel 4612 of transmission type, and an emission-side polarizer 4613 that transmits s-polarized light. The incident-side polarizer 4611, the liquid crystal panel 4612, and the emission-side polarizer 4613 are linearly disposed on the optical path of the modulated light emitted from the dimming device 45. Moreover, the liquid crystal panel 4612 is disposed at the image forming position of first modulated light by a relay device to be described later.

The first light modulation device 461 described above is provided for each of the color lights. That is, the first light modulation device 461R for red light is disposed on the X-direction side of the cross dichroic prism 462; the first light modulation device 461G for green light is disposed on the side of the cross dichroic prism 462 opposite to the Z-direction; and the first light modulation device 461B for blue light is disposed on the side of the cross dichroic prism 462 opposite to the X-direction.

### [Configuration of Dimming Device]

The dimming device 45 modulates incident color light and causes modulated light obtained by adjusting, on a region-by-region basis, the illuminance of the color light in the plane orthogonal to the central axis thereof to be incident on the electro-optic device 46. The dimming device 45 is provided for each of the color lights.

The dimming devices are configured similarly excepting that the dimming device 45R for red light is one obtained by reversing the dimming device 45B for blue light in the X-direction, and that the dimming device 45G for green light is one obtained by rotating the dimming device 45B for blue light 90 degrees counterclockwise in the ZX plane. Hereinafter, the dimming device 45B for blue light will be described.

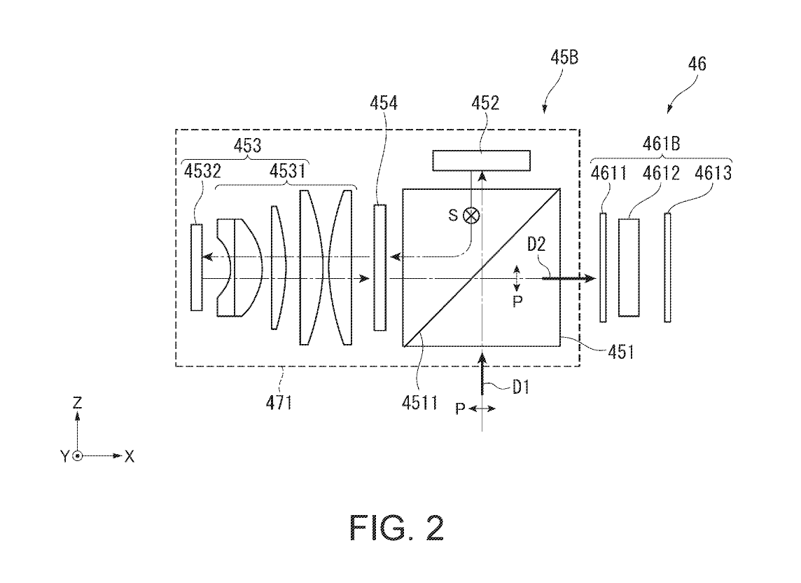

FIG. 2 is a schematic view showing the dimming device 45B for blue as one of the dimming devices 45.

The dimming device 45B modulates blue light incident in a first direction D1 and emits the first modulated light in a second direction D2 orthogonal to the first direction D1. In the dimming device 45B, the first direction D1 is parallel to the Z-direction, and the second direction D2 is parallel to the X-direction.

The dimming device 45B includes the polarization separation device 451, the second light modulation device 452, a relay device 453, and a λ/4 plate 454 as a retardation film, and is disposed on the side of the first light modulation device 461B opposite to the X-direction.

The polarization separation device 451 includes the polarization separation layer 4511 inclined with respect to the first direction D1, reflects s-polarized light incident on the polarization separation layer 4511, and transmits p-polarized light. The polarization separation device 451 is disposed such that the polarization separation layer 4511 is orthogonal to the ZX plane and inclined 45° in the X-direction with respect to the first direction D1 (i.e., the Z-axis).

The polarization separation device 451 is a cubic-shaped polarization separation element, and includes two right-angle prisms and the polarization separation layer 4511 as an optical film that is disposed between the right-angle prisms, reflects s-polarized light, and transmits p-polarized light.

The second light modulation device 452 is a liquid crystal panel of reflection type for adjusting illuminance. The second light modulation device 452 is disposed on the first direction D1 (the Z-direction) side of the polarization separation device 451, modulates color light as p-polarized light transmitted through the polarization separation layer 4511 in the first direction D1, and emits modulated light as s-polarized light in the direction opposite to the first direction D1. The modulated light as s-polarized light is reflected by the polarization separation layer 4511 in the direction opposite to the X-direction and opposite to the second direction D2 orthogonal to the first direction D1.

Compared to the first light modulation device 461, the second light modulation device 452 may be different in the area and resolution of an image forming region. For example, a liquid crystal panel having a resolution lower than that of the first light modulation device 461 for forming an image may be used for the second light modulation device 452 for dimming.

The relay device 453 is an image-forming optical system of reflection type that forms an image of incident modulated light in the vicinity of the liquid crystal panel 4612 of the first light modulation device 461, and includes a lens group 4531 and a mirror 4532. The relay device 453 is disposed on the side of the polarization separation device 451 opposite to the second direction D2, that is, on the side of the polarization separation device 451 opposite to the emission side of modulated light. After the modulated light reflected by the polarization separation layer 4511 passes through the lens group 4531 in the direction opposite to the second direction D2, is reflected by the mirror 4532, and passes through the lens group 4531 in the second direction D2, the image of the modulated light is formed in the vicinity of the liquid crystal panel 4612.

Although not shown in the drawing, minute irregularities are formed on the mirror 4532. The image (the image of modulated light by the second light modulation device 452) of the modulated light formed in the vicinity of the liquid crystal panel 4612 is scattered by the irregularities. Due to this, the illumination range of modulated light by each of pixels of the second light modulation device 452 is enlarged, the modulated light by each of the pixels of the second light modulation device 452 is incident on the area including a corresponding pixel and a black matrix surrounding the pixel in the liquid crystal panel 4612, and thus the black matrix is less conspicuous in a projection image. In addition, the occurrence of image distortion such as moire is suppressed.

The λ/4 plate 454 is disposed on the optical path of modulated light reflected by the polarization separation layer 4511. The modulated light passes through the λ/4 plate 454 to be converted to substantially clockwise or counterclockwise circularly polarized light, and is reflected by the mirror 4532 of the relay device 453 to be converted to substantially circularly polarized light rotating in the opposite direction. Thereafter, the light passes again through the λ/4 plate 454. Due to this, the modulated light is emitted as s-polarized light from the polarization separation device 451 and incident as p-polarized light on the polarization separation device 451.

The dimming device 45R for red light modulates red light incident in the Z-direction, and emits the first modulated light in the direction opposite to the X-direction. Moreover, the dimming device 45G for green light modulates green light incident in the direction opposite to the X-direction, and emits the first modulated light in the Z-direction.

### [Configuration of Optical Component Housing]

The optical component housing 47 includes a component accommodating member that accommodates various optical components, and a lid-like member that closes an opening formed in the component accommodating member and used for accommodating the components. An illumination optical axis is set inside the optical component housing 47, and the devices 41 to 46 are disposed at predetermined positions with respect to the illumination optical axis.

The optical component housing 47 includes, as shown by the broken lines in FIG. 1, arrangement sections 471 in which the dimming devices 45 are removably disposed as detachable components.

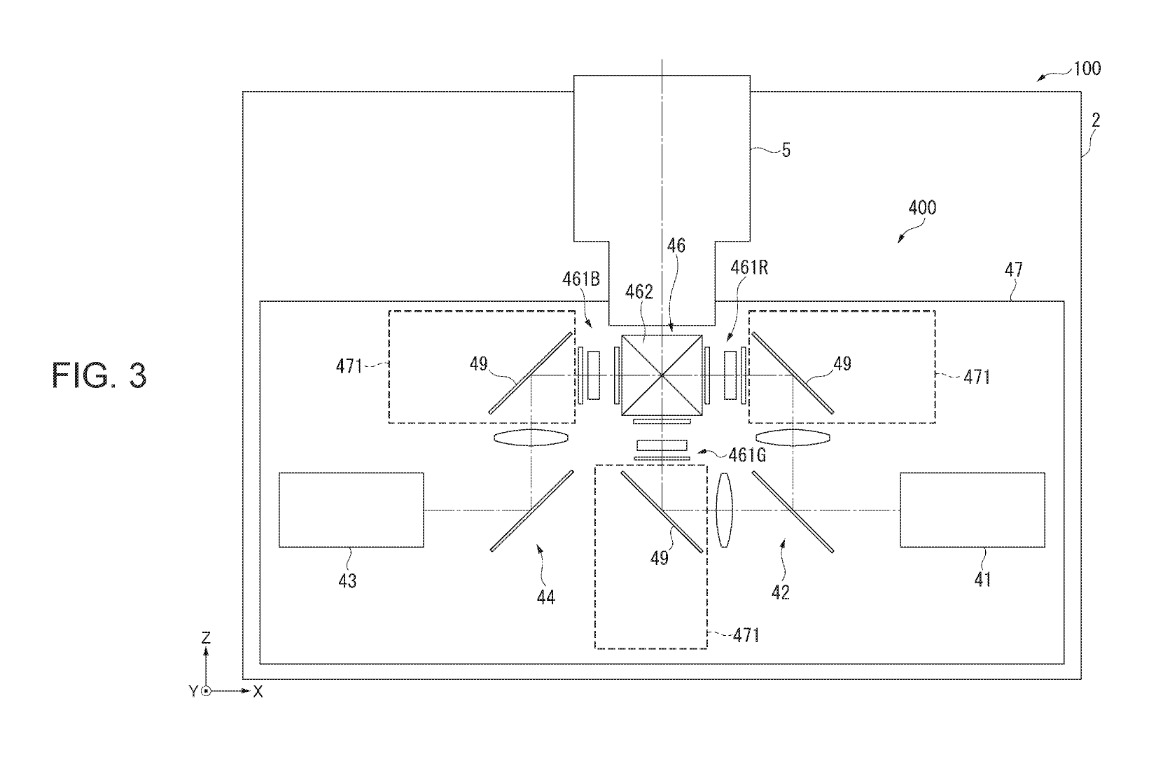

The arrangement section 471 is a groove or the like of the optical component housing 47 for disposing the members of the dimming device 45 at predetermined positions with respect to the illumination optical axis. Moreover, the arrangement section 471 is configured such that a reflection mirror 49 (see FIG. 3) can be disposed therein as an alternative component having a function different from the dimming device 45.

FIG. 3 is a schematic view showing the configuration of a projector 100 according to the embodiment.

The projector 100 includes configurations similar to those of the projector 1 excepting that the projector 100 includes an optical unit 400 in which the reflection mirrors 49 are disposed instead of the dimming devices 45.

The reflection mirror 49 is a light guide member that directs light incident in the first direction D1 to the electro-optic device 46, and is disposed in the arrangement section 471 such that a reflection surface coincides with the polarization separation layer 4511 of the polarization separation device 451. In the state where the reflection mirror 49 is disposed, light from each of the illumination devices 41 and 43 travels along the optical axis and is superimposed on the first light modulation device 461.

As described above, by disposing the dimming device 45 in the arrangement section 471, the projector 1 in which two light modulators are disposed in series can be configured. On the other hand, by disposing the reflection mirror 49 in the arrangement section 471, the projector 100 in which one light modulator is disposed can be configured.

That is, in the projector 1 and the projector 100, the devices 41 to 44 and 46 other than the dimming device 45 and the reflection mirror 49 are disposed along the illumination optical axis set in the optical component housing 47.

### Advantageous Effects of First Embodiment

According to the projector 1 according to the embodiment described above, the following advantageous effects are provided.

In the dimming device 45, the light from the illumination devices 41 and 43 is modulated and reflected by the second light modulation device 452 of reflection type, and an image of the reflected modulated light is formed on the first light modulation device 461 by the relay device 453 of reflection type.

In the dimming device 45 configured as described above, the optical path can be designed such that the optical path length from the illumination devices 41 and 43 to the second light modulation device 452 is substantially the same as the optical path length to the first light modulation device 461 in the case of provisionally removing the dimming device 45. Due to this, the projector 100 not having a dimming function can be configured by removing the dimming device 45 from the projector 1, and commonality of most of constituent components can be achieved between the projector 1 including the dimming device 45 and the projector 100 of another type not including the dimming device 45. Accordingly, costs in manufacturing a plurality of different types can be reduced, and in addition, the time required to develop the plurality of types can be shortened.

In the dimming device 45, the light passing through the polarization separation device 451 is modulated by the second light modulation device 452, incident as modulated light again on the polarization separation device 451, passes through the polarization separation device 451, and is incident on the relay device 453 of reflection type. In the course of being reflected by the relay device 453 of reflection type and incident again on the polarization separation device 451, the light converted to substantially circularly polarized light by the λ/4 plate 454 is reflected and the rotational direction of the substantially circularly polarized light is reversed, whereby the polarization direction of the modulated light is converted. Then, the converted modulated light is emitted from the polarization separation device 451 in the second direction D2 orthogonal to the first direction D1 as the incident direction of light from each of the illumination devices 41 and 43.

According to this, since the amount of transmitted light is adjusted by the two light modulation devices 452 and 461 disposed in series along the optical path, the contrast in the projection image projected by the optical projection device 5 can be improved.

Moreover, in the dimming device 45, after the modulated light is incident on the relay device 453 of reflection type and reflected by the relay device 453, in the course of being emitted from the relay device 453 and incident again on the polarization separation device 451, the polarization direction is converted. Accordingly, the modulated light incident from the second light modulation device 452 and the modulated light reflected by the relay device 453 can be reliably separated by the polarization separation device 451 by the difference in polarization direction. Due to this, the modulated light by the second light modulation device 452 can be reliably directed to the relay device 453, and in addition, the modulated light that is reflected by the relay device 453 and whose image is formed on the first light modulation device 461 can be reliably emitted to the first light modulation device 461 side.

Moreover, since the relay device 453 of reflection type is employed, the distance between the first light modulation device 461 and the second light modulation device 452 can be shortened. Accordingly, the projector 1 can be downsized.

A light modulation device (liquid crystal panel) of reflection type is used as the second light modulation device 452. Due to this, even when an optical component such as a lens is disposed on the light incident side of the dimming device 45, it is easy to dispose the second light modulation device on the side opposite to the light incident side, that is, at a position not interfering with the optical component. For this reason, design flexibility can be improved.

The dimming device 45 emits the modulated light, obtained by modulating the light incident from the illumination device, in the second direction D2 orthogonal to the first direction D1 as the incident direction.

By the use of the dimming device 45 configured as described above, the dimming device 45 can be disposed at the arrangement position of the reflection mirror 49 in the projector 100 not provided with a dimming device, and in addition, the mirror can be omitted.

The second light modulation device 452 is disposed on the first direction D1 side, and the relay device 453 is disposed on the side opposite to the second direction D2.

According to the configuration described above, the light incident along the first direction D1 on the dimming device 45 is incident on the second light modulation device 452 through the polarization separation device 451, and the modulated light reflected by the second light modulation device 452 is incident again on the polarization separation device 451. Then, the modulated light is reflected in the direction opposite to the second direction D2 by the polarization separation device 451 and is incident on the relay device 453. The modulated light reflected by the relay device 453 is emitted in the second direction D2 through the polarization separation device 451. According to this, the configurations of the dimming device 45 can be disposed reliably compactly.

### Second Embodiment

Next, a second embodiment of the invention will be described.

A projector according to the embodiment includes configurations similar to those of the projector 1. Here, the dimming device 45 including the polarization separation device composed of a prism-type PBS has been mentioned as the optical component disposed in the arrangement section in the projector 1. In contrast to this, in the projector according to the embodiment, a dimming device including a polarization separation device composed of a plate-type PBS, instead of the prism-type PBS, is disposed. In this regard, the projector according to the embodiment differs from the projector 1. In the following description, a description of the same or substantially the same portions as the portions already described is omitted.

### [Schematic Configuration of Projector]

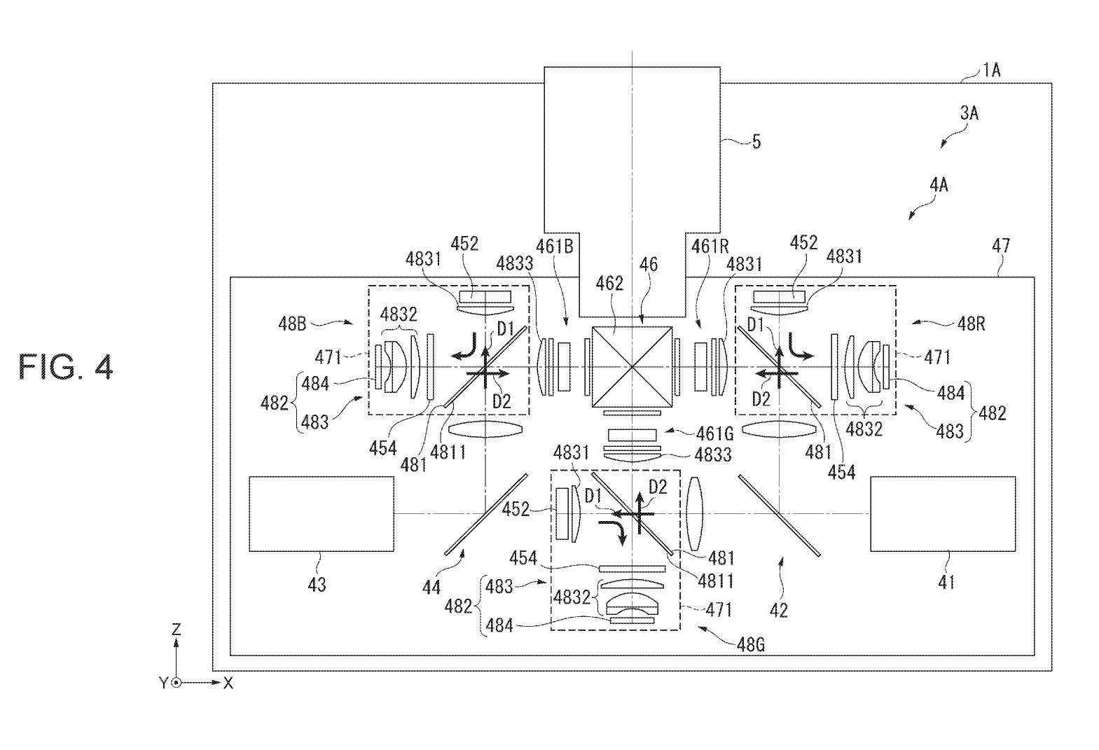

FIG. 4 is a diagram showing a schematic configuration of a projector 1A according to the embodiment.

The projector 1A according to the embodiment includes a device main body 3A accommodated in the external housing 2 as shown in FIG. 4. The device main body 3A includes an optical unit 4A and the optical projection device 5. Compared to the projector 1, the optical unit 4A includes configurations and functions similar to those of the projector 1 excepting that the optical unit 4A includes a dimming device 48 instead of the dimming device 45.

### [Configuration of Dimming Device]

Similarly to the dimming device 45 of the first embodiment, the dimming device 48 adjusts the illuminance of luminous flux of incident color light in the plane orthogonal to the central axis thereof, and causes the first modulated light asp-polarized light to be incident on the electro-optic device 46.

The dimming device 48 is provided for each of color lights. The dimming device for red light is referred to as a dimming device 48R; the dimming device for green light is referred to as a dimming device 48G; and the dimming device for blue light is referred to as a dimming device 48B. Hereinafter, the dimming device 48B for blue light will be described.

The dimming device 48B modulates blue light as p-polarized light incident in the first direction D1, and emits the first modulated light in the X-direction. The dimming device 48B includes the second light modulation device 452, the λ/4 plate 454, a polarization separation device 481, and a relay device 482.

The polarization separation device 481 is a plate-type PBS with a wire grid polarizing film attached thereto. The polarization separation device 481 is disposed such that a polarization separation layer 4811 is inclined at approximately 45 degrees with respect to the first direction D1. The polarization separation layer 4811 polarization-separates incident luminous flux through diffraction based on the grid structure. Specifically, the polarization separation device 481 transmits p-polarized light while reflecting s-polarized light of the light incident on the polarization separation layer 4811, thereby polarization-separating the incident light.

The relay device 482 is an image-forming optical system of reflection type that is disposed on the optical path, along which the illumination light incident on the second light modulation device 452 is emitted as the first modulated light toward the electro-optic device 46, and forms an image of the first modulated light on the liquid crystal panel 4612. The relay device 482 includes a lens group 483 and a mirror 484.

The lens group 483 includes a first field lens 4831, a lens unit 4832, and a second field lens 4833. The first field lens 4831 is disposed between the polarization separation layer 4811 and the second light modulation device 452. The lens unit 4832 is linearly disposed with the mirror 484 on the optical path of the first modulated light reflected by the polarization separation layer 4811. The second field lens 4833 is disposed between the polarization separation layer 4811 and the electro-optic device 46.

### [Configuration of Optical Component Housing]

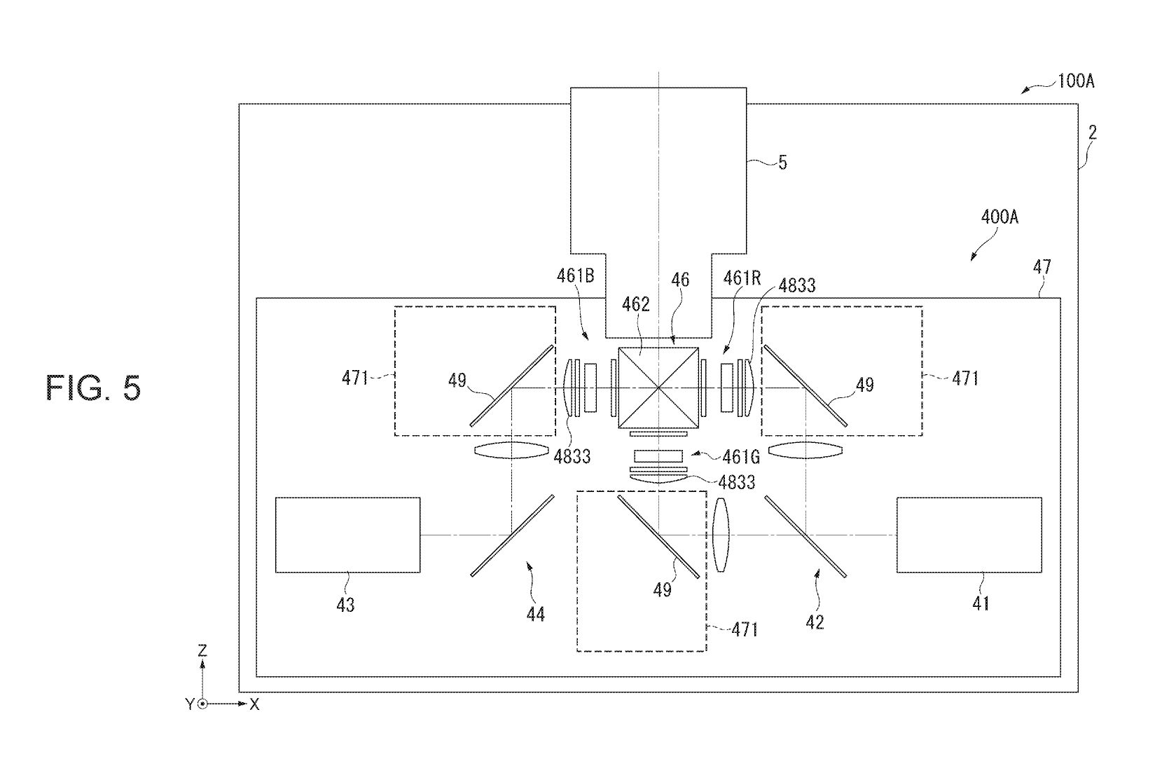

The optical component housing 47 includes, as shown by the broken lines in FIG. 4, the arrangement sections 471 in which the dimming devices 48 are removably disposed as detachable components. The members of the dimming device 48 are disposed to be freely detachable relative to the arrangement section 471. Moreover, the arrangement section 471 is configured such that the reflection mirror 49 (see FIG. 5) can be disposed therein as an alternative component of the dimming device 48 except for the second field lens 4833.

FIG. 5 is a schematic view showing the configuration of a projector 100A according to the embodiment.

The projector 100A includes configurations basically similar to those of the projector 1A excepting that the projector includes an optical unit 400A in which the reflection mirrors 49 are disposed instead of the members of the dimming devices 48 except for the second field lenses 4833.

The reflection mirror 49 is disposed in the arrangement section 471 such that the reflection surface coincides with the polarization separation layer 4811 of the polarization separation device 481.

As described above, by disposing the dimming device 48 in the arrangement section 471, the projector 1A in which two light modulators are disposed in series can be configured. On the other hand, by disposing the reflection mirror 49 in the arrangement section 471, the projector 100A in which one light modulator is disposed can be configured.

That is, in the projector 1A and the projector 100A, the devices 41 to 44 and 46 other than the dimming device 48 and the reflection mirror 49 are disposed along the illumination optical axis set in the optical component housing 47.

### Advantageous Effects of Second Embodiment

According to the projector 1A according to the embodiment described above, advantageous effects similar to those of the projector 1 can be provided, and in addition, the following advantageous effects can be provided.

Since the dimming device 48 includes the polarization separation device 481 having a plate shape, weight reduction can be achieved compared to when a polarization separation element having a prism shape is used.

Moreover, the polarization separation device 481 having a plate shape and the reflection mirror 49 can be configured so as to be replaced with each other substantially at the same position. For this reason, it is easy to achieve commonality of fixing structures of the polarization separation device 481 and the reflection mirror 49 in the arrangement section 471.

### Third Embodiment

Next, a third embodiment of the invention will be described.

A projector according to the embodiment includes configurations similar to those of the projector 1. Here, in the projector 1, the incident direction (the first direction D1) of incident light on the dimming device 45 and the emission direction (the second direction D2) of emitted light from the dimming device 45 are configured so as to be orthogonal to each other. In contrast to this, in the projector according to the embodiment, the incident direction of incident light on the dimming device and the emission direction of emitted light from the dimming device are configured so as to coincide with each other. In this regard, the projector according to the embodiment differs from the projector 1. In the following description, a description of the same or substantially the same portions as the portions already described is omitted.

### [Schematic Configuration of Projector]

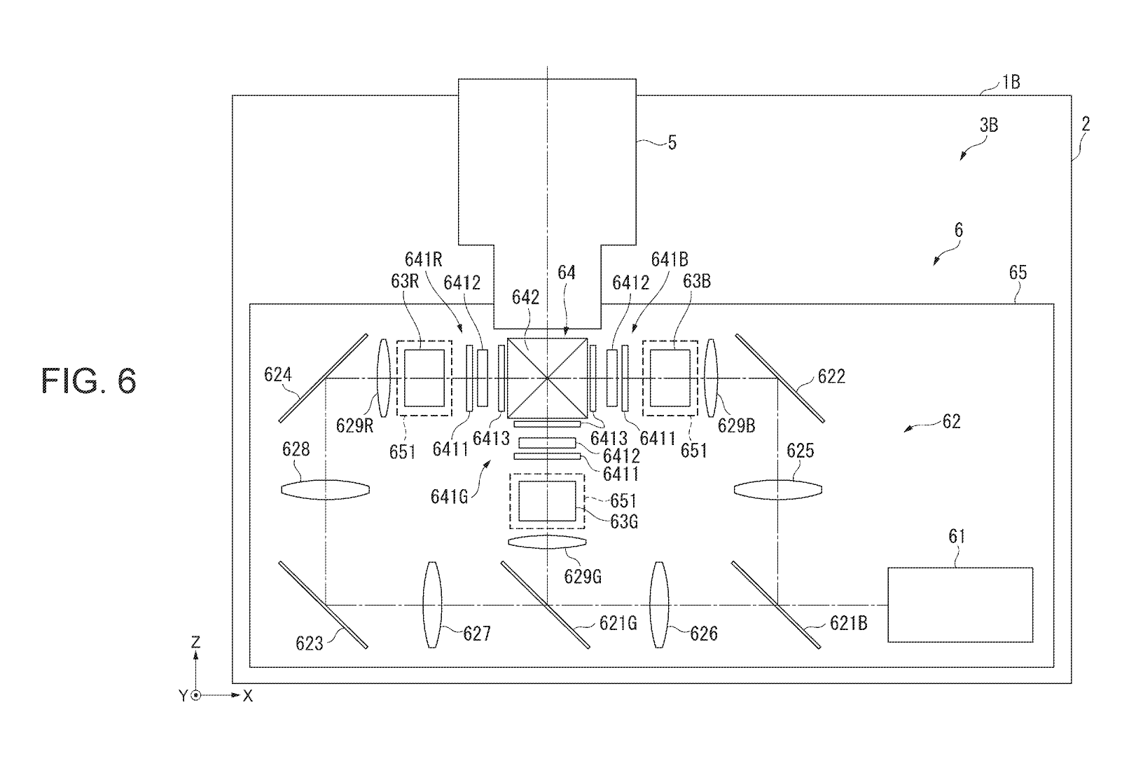

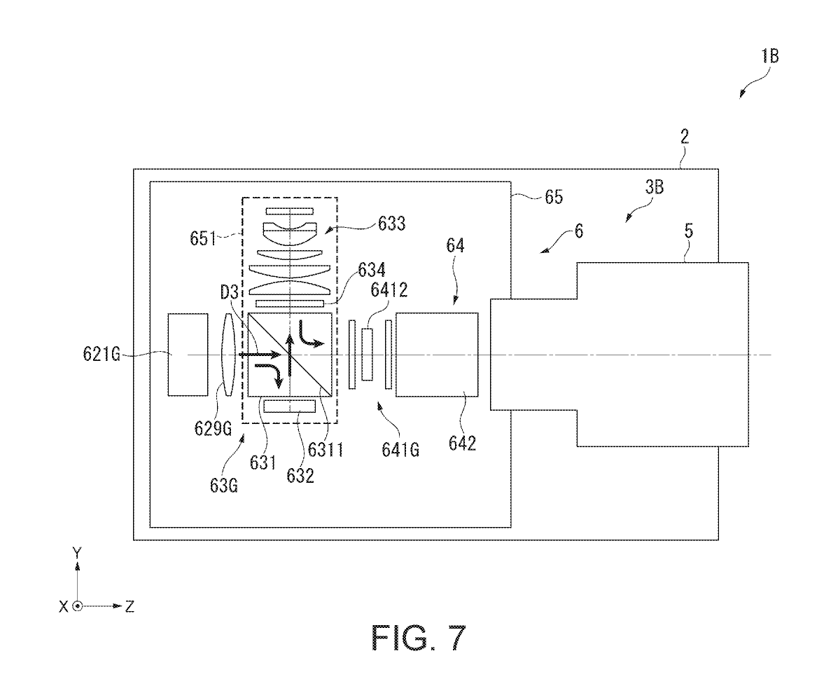

FIG. 6 is a schematic view showing the configuration of a projector 1B according to the embodiment. FIG. 7 is a schematic view showing the configuration of the projector 1B as viewed from the X-direction side.

The projector 1B according to the embodiment includes the external housing 2 and a device main body 3B accommodated in the external housing 2. The device main body 3B includes an optical unit 6 that forms a projection image and the optical projection device 5.

### [Configuration of Optical Unit]

The optical unit 6 includes an illumination device 61, a color separation optical device 62, dimming devices 63 (63R, 63G, 63B), an electro-optic device 64, and an optical component housing 65 that accommodates the devices 61 to 64. The devices 61 to 64 are disposed at predetermined positions with respect to an illumination optical axis set inside the optical component housing 65.

### [Configuration of Illumination Device]

The illumination device 61 emits illumination light whose illuminance in the plane orthogonal to the central axis of luminous flux is uniform. Moreover, the illumination device 61 emits, as the illumination light, linearly polarized light whose polarization direction is a direction orthogonal to the YZ plane (a direction parallel to the X-axis). Although not shown in the drawing, the illumination device 61 includes a light source device that emits light containing red light, green light, and blue light, and an illumination optical device as an integrator optical system.

p-polarized light and s-polarized light are defined with respect to a polarization separation layer 6311 of a polarization separation device 631 included in the dimming device 63 to be described later.

The color separation optical device 62 separates luminous flux incident from the illumination device 61 into three color lights of red, green, and blue. The color separation optical device 62 includes dichroic mirrors 621 (621B, 621G), reflection mirrors 622 to 624, relay lenses 625 to 628, and condensing lenses 629 (629R, 629G, 629B).

The dichroic mirrors 621 are each disposed inclined at an angle of approximately 45° with respect to the central axis (parallel to the X-axis) of luminous flux of the illumination light. The dichroic mirror 621B of these reflects the blue light and transmits the other color lights. Moreover, the dichroic mirror 621G reflects the green light and transmits the other color light.

The blue light is bent 90° in the Z-direction by the dichroic mirror 621B, bent 90° in the direction opposite to the X-direction by the reflection mirror 622, condensed by the condensing lens 629B, and incident on the dimming device 63B.

The dimming device 63, which will be described in detail later, adjusts the illuminance of each of the color lights and causes the modulated light to be incident on the electro-optic device 64.

Moreover, the green light is bent 90° in the Z-direction by the dichroic mirror 621G after passing through the dichroic mirror 621B, condensed by the condensing lens 629G, and incident on the dimming device 63G.

Moreover, the red light is bent 90° in the Z-direction by the reflection mirror 623 after passing through the dichroic mirrors 621B and 621G, bent 90° in the X-direction by the reflection mirror 624, condensed by the condensing lens 629R, and incident on the dimming device 63R.

The relay lens 625 is disposed on the optical path of blue light; the relay lens 626 is disposed on the optical path of green light; and the relay lenses 627 and 628 are disposed on the optical path of red light.

### [Configuration of Electro-Optic Device]

The electro-optic device 64 is configured substantially similarly to the electro-optic device 46 of the first embodiment, forms image lights by modulating, on a color-by-color basis, modulated lights emitted from the dimming devices 63 and corresponding to the respective colors of red, green, and blue, and combines the image lights to form a projection image. The electro-optic device 64 includes three first light modulation devices 641 (641R, 641G, 641B) and a cross dichroic prism 642.

The first light modulation device 641 includes an incident-side polarizer 6411 that transmits s-polarized light, a liquid crystal panel 6412, and an emission-side polarizer 6413 that transmits p-polarized light. The first light modulation device 641 modulates the first modulated light in response to an image signal, and causes the first modulated light to be incident on the cross dichroic prism 642 as second modulated light.

The cross dichroic prism 642 combines the second modulated lights of the respective colors to form a projection image, and emits the projection image toward the optical projection device 5.

### [Configuration of Dimming Device]

The dimming device 63 modulates incident color light and causes modulated light obtained by adjusting, on a region-by-region basis, the illuminance of the color light in the plane orthogonal to the central axis thereof to be incident on the electro-optic device 64. The dimming device 63 is provided for each of the color lights.

The dimming device 63R for red light is one obtained by rotating the dimming device 63G for green light 90 degrees clockwise in the ZX plane, and the dimming device 63B for blue light is one obtained by rotating the dimming device 63G for green light 90 degrees counterclockwise. Hereinafter, the dimming device 63G for green light will be described.

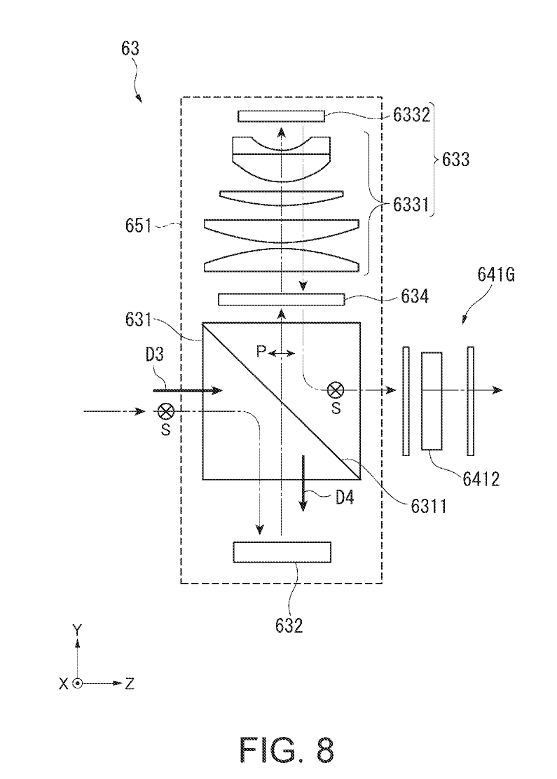

FIG. 8 is a schematic view showing the dimming device 63G for green as one of the dimming devices 63.

The dimming device 63G modulates green light incident in a first direction D3, and emits the first modulated light in the first direction D3. In the dimming device 63G, the first direction D3 is parallel to the Z-direction. The dimming device 63G includes the polarization separation device 631, a second light modulation device 632, a relay device 633, and a λ/4 plate 634.

The polarization separation device 631 is configured basically similarly to the polarization separation device 451 of the first embodiment excepting that the arrangement direction is different therefrom. The polarization separation device 631 includes the polarization separation layer 6311 reflecting s-polarized light and transmitting p-polarized light. The polarization separation device 631 is disposed such that the polarization separation layer 6311 is directed to the direction opposite to the Y-direction toward the Z-direction and is inclined at 45° with respect to the Z-axis.

The second light modulation device 632 is a liquid crystal panel of reflection type for adjusting illuminance. The second light modulation device 632 is disposed on a third direction D4 side of the polarization separation device 631, in which the third direction D4 is a direction orthogonal to the first direction D3 and opposite to the Y-direction. Color light as s-polarized light that is incident in the first direction D3 on the polarization separation layer 6311 and reflected in the third direction D4 is incident on the second light modulation device 632, and the second light modulation device 632 modulates the color light and emits the modulated light as p-polarized light in the direction opposite to the third direction D4.

The relay device 633 is configured basically similarly to the relay device 453 of the first embodiment, and is an image-forming optical system of reflection type that forms an image of the modulated light, emitted from the second light modulation device 632 and incident in the direction opposite to the third direction D4, on the liquid crystal panel 6412 of the first light modulation device 641. The relay device 633 includes a lens group 6331 and a mirror 6332, and is disposed on the side opposite to the third direction D4 (i.e., the side opposite to the incident side of the modulated light emitted from the second light modulation device 632) in the polarization separation device 631.

The λ/4 plate 634 is disposed between the polarization separation device 631 and the mirror 6332 as shown in FIGS. 7 and 8.

### [Configuration of Optical Component Housing]

An illumination optical axis is set inside the optical component housing 65, and the devices 61 to 64 are disposed at predetermined positions with respect to the illumination optical axis.

The optical component housing 65 includes, as shown by the broken lines in FIGS. 6 and 7, arrangement sections 651 in which the dimming devices 63 are removably disposed as detachable components.

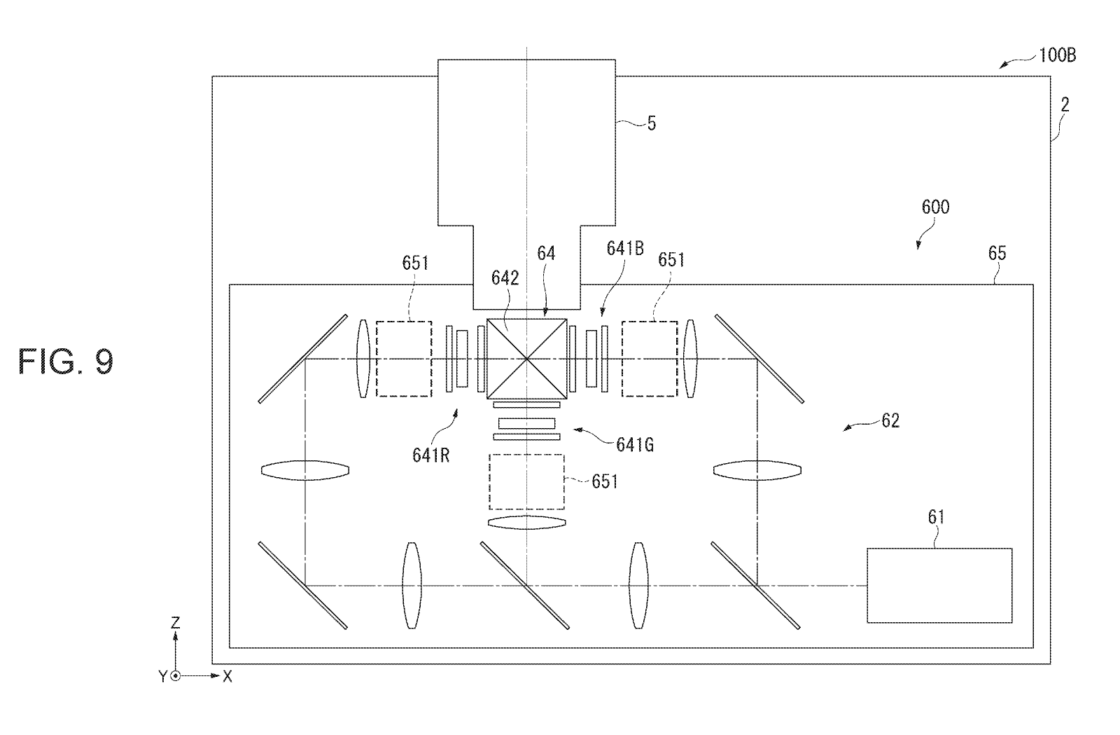

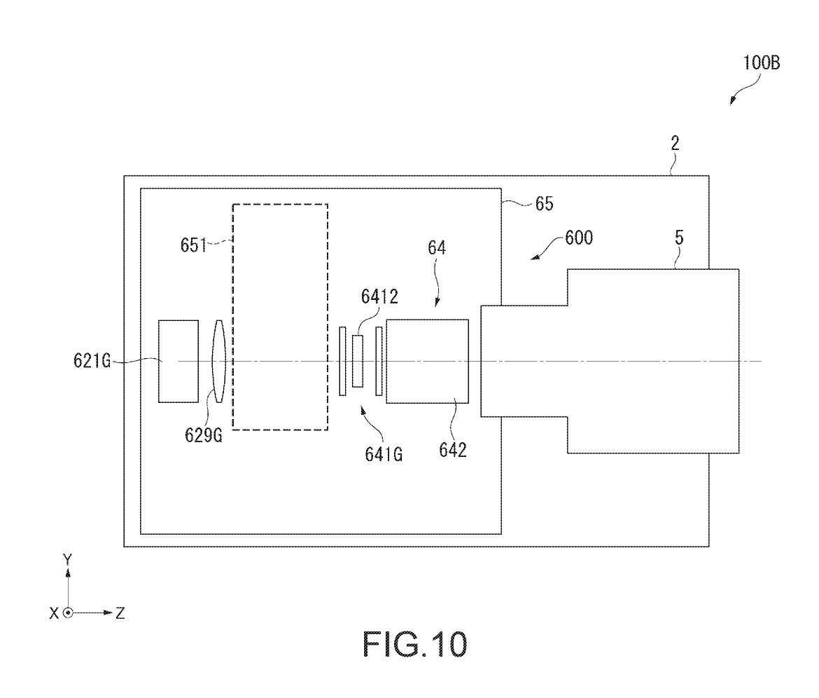

FIG. 9 is a schematic view showing the configuration of a projector 100B according to the embodiment. FIG. 10 is a schematic view showing the configuration of the projector 100B as viewed from the X-direction side.

The projector 100B includes configurations similar to those of the projector 1B excepting that the projector 100B includes an optical unit 600 not including the dimming device 63.

As described above, by disposing the dimming device 63 in the arrangement section 651, the projector 1B in which two light modulation devices are disposed in series is configured. On the other hand, by removing the dimming device 63 relative to the arrangement section 651, the projector 100B including one light modulation device is configured. The projector 1B and the projector 100B different from each other can share the optical components of the optical unit 6.

### Advantageous Effects of Third Embodiment

According to the projector 1B according to the embodiment as described above, advantageous effects similar to those of the projector 1 can be provided, and in addition, the following advantageous effects can be provided.

The incident direction of light on the dimming device 63 and the emission direction of modulated light by the dimming device 63 coincide with each other. According to this, the dimming device 63 can be easily disposed on the optical path of light emitted from the illumination device in the projector 100B without the dimming device 63. Accordingly, the projector 100B not including the dimming device can be made only by removing the dimming device 63 from the projector 1B including the dimming device 63. Moreover, since the arrangement orientation (the orientation of the rotational direction with the illumination optical axis as the axis of rotation) of the dimming device 63 can be changed, space can be effectively utilized, and the projector can be downsized.

In the dimming device 63, the incident direction of light from the illumination device 61 and the emission direction of modulated light are the first direction D3, and the relay device 633 is disposed along the optical axis parallel to the third direction D4.

In the configuration described above, the relay device 633 can be disposed along the Y-direction with respect to the ZX plane on which the illumination optical axis is set. For this reason, the occupied area of the dimming device 63 on the ZX plane can be reduced, and thus the downsizing of the projector 1B can be achieved.

Moreover, in the dimming device 63, the polarization separation device 631 and the relay device 633 are disposed along the third direction D4 substantially orthogonal to the first direction D3. In addition, the second light modulation device 632 and the relay device 633 are disposed on opposite sides from each other with the polarization separation device 631 interposed therebetween. In the dimming device 63 described above, in designing the arrangement attitude thereof, it is possible while maintaining the incident direction and the emission direction to select the arrangement attitude from a plurality of attitudes (e.g., an attitude in which the relay device is disposed along the vertical direction or an attitude in which the relay device is disposed along the horizontal direction when normally placed) in the rotational direction about a virtual line overlapping the first direction D3, and the flexibility of the arrangement attitude can be improved.

Moreover, even when the second light modulation device 632 and the relay device 633 are disposed so as to face each other along the horizontal direction (i.e., when disposed along a virtual plane on which the illumination optical axis is set), the arrangement positions of the second light modulation device and the relay device can be selected considering space efficiency. Moreover, the arrangement of the dimming device 63 can be selected similarly considering space efficiency such that the second light modulation device 632 and the relay device 633 are disposed along the vertical direction (i.e., to be orthogonal to the virtual plane on which the illumination optical axis is set). Accordingly, the downsizing of the projector 1B can be achieved.

### Modifications of Embodiments

The invention is not limited to the embodiments, but modifications, improvements, and the like within the scope capable of achieving the objects of the invention are included in the invention.

Although the configuration in which the dimming device is a detachable component has been illustrated in the embodiments, the invention is not limited to this. An optical component other than the dimming device maybe detachable. For example, a portion of the dimming device may be detachable, and the polarization separation element may be configured to be replaceable with a mirror or a wire grid.

Moreover, although the projector configured such that the dimming device can be detachably attached thereto has been illustrated in the embodiments, the invention is not limited to this. The dimming device may be fixed at a predetermined attachment position.

In the first embodiment and the second embodiment, the reflection mirror 49 is disposed as an alternative component instead of the dimming device, whereby the illumination optical axis set at the time of disposing the alternative component is configured so as to coincide with a portion of the illumination optical axis set at the time of disposing the dimming device. However, the invention is not limited to this. For example, when the alternative component is disposed, the light traveling direction may be away from the illumination optical axis at the time of disposing the dimming device due to the optical component disposed in the arrangement section. That is, even when the optical axis is changed in the arrangement section, it is sufficient that the optical axis is not changed in an upstream side-optical path to the arrangement section and a downstream side-optical path from the arrangement section, and also in this case, the optical components can be shared.

In the first and second embodiments, the configuration of using the dimming devices 45 and 48 in which the incident direction and the emission direction of light are orthogonal to each other has been illustrated; and in the third embodiment, the configuration including the dimming device 63 in which the incident direction and the emission direction of light are the same direction has been illustrated. However, the invention is not limited to this, and a configuration including two or more types of the dimming devices 45, 48, and 63 at the same time may be employed.

Although the configuration in which the polarization separation device includes the polarization separation layer reflecting s-polarized light and transmitting p-polarized light has been illustrated in the embodiments, the invention is not limited to this. That is, a polarization separation device that transmits s-polarized light and reflects p-polarized light may be employed.

Although the projector includes the first light modulation devices in the embodiments, the invention is not limited to this. That is, the invention can be applied also to a projector using two or less, or four or more, first light modulation devices.

Moreover, in the embodiments, the arrangement positions of the optical components in the optical unit can be appropriately changed, and for example, a configuration having a substantially L-shape in a plan view, or a configuration having a substantially U-shape in a plan view may be employed.

Although the configuration of employing the liquid crystal panel as a light modulator has been illustrated in the embodiments, light modulators of other configurations may be employed as long as the light modulator can modulate incident luminous flux in response to a control signal (image information). For example, the invention can be applied also to a projector using a light modulator other than liquid crystal, such as a device using a micromirror. Even when the light modulation device described above is used, the polarization direction of modulated light is appropriately set by appropriately disposing a polarizer.

The entire disclosure of Japanese Patent Application No. 2015-57418, filed Mar. 20, 2015 is expressly incorporated by reference herein.

1. A projector comprising:
an image forming device forming an image; and
a optical projection device projecting the image formed,
the image forming device including
an illumination device,
a first light modulation device modulating light emitted from the illumination device, and
a dimming device disposed on an optical path between the illumination device and the first light modulation device and adjusting, on a region-by-region basis, the illuminance of the light emitted from the illumination device in a plane orthogonal to a central axis of the light,
the dimming device including
a second light modulation device of reflection type modulating the light emitted from the illumination device, and
a relay device of reflection type forming an image of modulated light modulated by the second light modulation device on the first light modulation device.

2. The projector according to claim 1, wherein
the dimming device includes
a polarization separation device directing the modulated light incident from the second light modulation device to the relay device and emitting the modulated light reflected by the relay device to the first light modulation device side, and
a retardation film disposed between the polarization separation device and the relay device and converting incident light to substantially circularly polarized light.

3. The projector according to claim 2, wherein
the dimming device emits light incident along a first direction in a second direction substantially orthogonal to the first direction.

4. The projector according to claim 3, wherein
the second light modulation device is disposed on the first direction side with respect to the polarization separation device, and
the relay device is disposed on a side opposite to the second direction with respect to the polarization separation device.

5. The projector according to claim 2, wherein
the dimming device emits light incident along a first direction along the first direction.

6. The projector according to claim 5, wherein
the second light modulation device is disposed in a third direction substantially orthogonal to the first direction with respect to the polarization separation device, and
the relay device is disposed on a side opposite to the third direction with respect to the polarization separation device.

7. A projector comprising:
an image forming device forming an image; and
a optical projection device projecting the image formed,
the image forming device including
an illumination device,
a first light modulation device modulating light emitted from the illumination device, and
an optical component housing in which the first light modulation device can be disposed at a predetermined position,
the optical component housing being configured such that a dimming device adjusting, on a region-by-region basis, the illuminance of the light emitted from the illumination device in a plane orthogonal to a central axis of the light can be disposed on an optical path between the illumination device and the first light modulation device,
the dimming device including
a second light modulation device of reflection type modulating the light emitted from the illumination device,
a relay device of reflection type forming an image of modulated light modulated by the second light modulation device on the first light modulation device,
a polarization separation device directing the modulated light incident from the second light modulation device to the relay device and emitting the modulated light reflected by the relay device to the first light modulation device side, and
a retardation film disposed between the polarization separation device and the relay device and converting incident light to substantially circularly polarized light.

8. The projector according to claim 7, wherein
when the dimming device is not disposed in the optical component housing, a reflection device reflecting at least portion of light is disposed at a place at which the polarization separation device can be disposed.
